(19) United States
(12) Patent Application Publication
(10) Pub. No.: US 2012/0006571 A1
(43) Pub. Date: Jan. 12, 2012

(54) LAWN MOWER MOUNTED PLUG AERATOR

(76) Inventor: Ryan Sprouse Dart, Raleigh, NC (US)

(21) Appl. No.: 12/834,292

(22) Filed: Jul. 12, 2010

(51) Int. Cl. A01B 45/02

(52) U.S. Cl. 172/22

(57) ABSTRACT

The present invention relates to a lawn aerating apparatus designed for attachment to the face of a wheel. Attachment is by one or more bolts and is configured to cut one or more cylindrical soil plugs while traversing the lawn. The device is adjustable for mounting on the face different wheel configurations plus clamping to the tread, as well as for adjusting the depth of the plugs that are cut.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a device for aerating lawns. In particular, it relates to a device for attaching to the wheels of a lawn mower and pulling aerating dirt plugs from the lawn while using the lawn mower.

2. Description of Related Art

The aeration of a lawn is utilized for improving the penetration of water to the lawn as well as provide greater access of applied nutrients and crop chemicals, such as insecticides and fungicides. Aeration is accomplished by creating a hole in the lawn, such as with a spike or knife blade, or by pulling plugs, i.e. removing cylinders of soil from the lawn.

The more effective of the two are the devices that pull or cut plugs from the lawn. Spike aeration only provides some air to the lawn. Cutting a plug reduces compaction as well as provides air to the lawn. However, the devices that are capable of pulling plugs are large, expensive commercial units that are impractical for use by a homeowner. While they can be rented for a single use, they are dangerous to operate and still a very expensive per use way of aerating the lawn.

Attempts to provide devices that aerate the lawn by the homeowner have been limited chiefly to blade or spike type devices which poke a hole rather than pull a plug. Because of the difficulty in providing a pulled plug without the device jamming up and the reduced cost of attaching a device which pokes holes to a lawn mower, the easier hole method has been preferred.

Examples of devices with blades, spikes, or the like for attaching to the lawn mower include U.S. Pat. Nos. 5,662,172; 5,906,090; and 5,934,055 which show blade or hole poking devices either removably attached to the wheel or cast into the wheel itself. An obvious problem with an aeration device molded into the wheel is that separate wheels must be utilized if the mower is to be moved over the side walk, driveway, or the like and one is buying wheels in addition to the aerator spikes. The idea of attaching a device removably from a wheel solves that problem but then one must have a different device for each lawn mower that has a different bolt pattern for holding on the lawn mower wheel. In addition, there is no such device which produces a pulled plug.

### BRIEF SUMMARY OF THE INVENTION

The present invention relates to the discovery that a plug can be pulled from a lawn by attaching an apparatus of the present invention to the wheel of a vehicle such as a riding or push lawn mower. The problem of removing the plug is solved by positioning a plug cutter with the portion proximal to the device cut out such that the plugs will fall from the device as each successive plug is cut. In addition, in some embodiments a universal adaptor is provided such that the apparatus can be attached to virtually any lawn mower wheel or other vehicle wheel that has one or more bolts on the wheel.

Accordingly, in one embodiment of the present invention there is described a lawn aerating apparatus designed for attachment to the face of the wheel of a vehicle, the wheel having a tread, a selected radius, and a center point wherein the wheel is attached to the vehicle by one or more attachment bolts and wherein the apparatus aerates by cutting one or more cylindrical soil plugs while the vehicle is traversing over a lawn comprising:
a) a mounting plate for mounting the apparatus to the face of the vehicle wheel by attachment to the vehicle wheel attachment bolts wherein the mounting plate has a center point designed to be adjacent to the wheel center point when the apparatus is attached to the wheel;
b) one or more cylindrical soil plug cutters having a cylindrical side, a sharpened distal end, a proximal end and wherein a portion of the cylindrical side at the proximal end is open, the plug cutters attached to the apparatus with the sharpened distal end facing distally on a radius from the center point of the mounting plate and positioned such that the sharpened distal end is at a greater distance from the mounting plate center point than the radius of the wheel; and
c) a plurality of adjustable clamps attached to the apparatus designed for clamping the apparatus to the tread of the vehicle wheel.

### BRIEF DESCRIPTION OF THE DRAWINGS

FIG. 1 is a perspective view of the lawn aerating apparatus.

FIG. 2 is a frontal view of the lawn aerating apparatus showing a first wheel adaptor bolt position.

FIG. 3 is a frontal view of the lawn aerating apparatus showing a second wheel adaptor bolt position.

FIG. 4 is a perspective view of the inside of a lawnmower wheel with the apparatus mounted on the outside.

FIG. 5 is a perspective view of an embodiment of the device mounted on a lawn mower wheel.

FIG. 6 is a perspective view of a different plug cutter embodiment.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “lawn aerating apparatus” refers to, for the purpose of this invention in the claims, as a device which aerates (and reduces compaction) by cutting and removing a soil plug. Further, in some embodiments the apparatus is also designed to eject the soil plug to make room for subsequent plugs without blocking the plug cutters of the invention.

As used herein the term “vehicle” refers to a device that has wheels and can safely traverse a lawn, i.e. without damaging the lawn. In one embodiment, the vehicle is a lawn mower such as a manual or motorized push mower, or in one embodiment a riding lawnmower, in yet other embodiments the vehicle can be a tractor or a wheeled device pulled behind a lawn mower, tractor, or the like. These vehicles are all wheeled vehicles with the “wheel” being a standard wheel suitable for running over a lawn and suitable for the vehicle. In one embodiment, this wheel has a tread of the standard materials and an attachment to the vehicle by one or more attachment bolts (a nut and bolt assembly), for example, one in the center of the wheel, a pattern of bolts around the side of the wheel, or both. Most vehicles for use with the present apparatus will have this configuration but because of the varying patterns of the bolt, attachment would have to have a different device for mounting unless used with the embodiment herein where an adjustable mounting pattern is available and not just a bolt pattern matching an individual wheel.

The lawn aerating apparatus is used by attaching the apparatus to the wheel of a vehicle by using the attachment nut and bolt assembly of the wheel on the vehicle to mount the apparatus on the face of the wheel as can be readily seen in the example drawings which follow. This is accomplished by use of a mounting plate for mounting the apparatus onto the face of the wheel. The mounting plate has holes which mate the mounting bolt pattern of the individual wheel of the vehicle. This way the individual bolts of the wheel can be used by removing the nuts, placing the mounting plate on the bolt pattern by matching the holes to the bolts, and then reattaching the nuts. Where the bolts are too short, bolt extenders can be utilized. The mounting plate can be round or roundish with scallops as in the drawings or any shape as long as it is smaller than the area of the face of the wheel. The thickness of the plate needs to be sufficient to sustain the pressure of the activity and still fit on the wheel. In general, the mounting plate will be from about an eighth to a half inch in thickness. The thickness will depend on the particular material utilized but in general a metal would be used, such as stainless or hardened steel, but any metal, plastic, or the like can be used to make the plate. The center point of the mounting plate or other center point of the apparatus is designed to be centered over the center point of the wheel of the vehicle during the mounting of the apparatus on the vehicle. The center point is also used to aim the soil plug cutters as described below.

Attached to the apparatus are one or more “cylindrical soil plug cutters”. A soil plug cutter is a cylinder designed to be inserted into the ground when the apparatus is in operation and when removed the device has removed a plug of soil. As used herein for the claimed invention, a “soil plug cutter” is a cylinder having a cylindrical side, a sharpened distal end, and a proximal end, wherein a portion of the cylindrical side starting from the proximal side is open. The opening extends from about one quarter to about three quarters of the length of the cylinder. The opening is designed to allow the soil plug cut with the distal end to fall out when it reaches the side opening. The opening needs to be roughly at least about half of the side of the cylinder at some point to allow the plug to fall out without resistance, but the amount of side removed must also be balanced with leaving enough of the cylinder to attach to the device. This cut out portion or opening can be a tapered shape, be of straight parallel sides, or both. Where tapered, the opening starts from less than half of the side and tapers to more open at the proximal side. This embodiment is shown in the drawings. The distal end is sharpened all the way around the distal edge of the cylinder. A tapering edge is utilized but any method of sharpening the edge for soil penetration purposes is intended.

The attachment of the soil plug cutters to the apparatus is accomplished by attaching a portion of the cylinder side at the proximal end (essentially the side opposite the open cylinder side) to the mounting plate or to the adjustable clamps which are then attached to the mounting plate. This can be done by welding, molding, shaping, or the like for fabrication of metal parts. The soil plug cutters are positioned with the sharpened distal end facing distally on a radius from the center point of the mounting plate. In addition, it is necessary that when in use, the soil plug cutter extends past the edge of the wheel so as the apparatus rotates on a rotating wheel, the soil plug cutter will puncture the ground as it reaches the bottom of the wheel during wheel rotation. Accordingly, the soil plug cutter needs to be positioned wherein the sharpened distal end is positioned at a greater distance from the mounting plate center than the length of the radius of the wheel it is being used on. The length of the plug cut is determined by how far past the radius the plug cutter is positioned. For example, where the plug cutter is positioned 1.5 inches past the radius, an approximately 1.5 inch plug of soil is removed as the soil plug cutter moves in and out of the soil. This can further be seen by the attachment to a wheel shown in the drawings.

Once a plug is cut from the soil as it moves in and out of the soil, the plug remains in the cutter cylinder. However, when the cutter comes around again to cut another plug, the next plug pushes the first plug up higher into the cylinder. The open hole on the proximal end of the cylinder causes the first plug to fall out of the cylinder. Repeated cutting of plugs causes each successive plug to be pushed out the side of the cylinder. Accordingly, the hole in the side of the cylinder needs to be wide enough to accommodate the width of the soil plug to allow it to be pushed out during operation of the apparatus.

In addition to the mounting plate adapted for attaching the apparatus to the wheel of a vehicle, the apparatus has a plurality of adjustable clamps adapted for attaching the apparatus to the tread of the vehicle wheel. In embodiments, the number of clamps are 2, 3, 4, 5, 6, 7, 8 or more clamps. The “clamps” of the present invention have a portion for mounting adjustably to the mounting plate and a right angle portion for gripping the tread of a wheel when the mounting plate portion is adjusted radially toward the center point of the apparatus. Thus, when each of the clamps are moved inward toward the radius, the clamps grip the wheel together. The action of the clamps and mounting plate attached to the wheel gives the stability and strength needed to continually cut soil plugs without bending, breaking, or tearing off the vehicle wheel. An adjustable clamp can be done by slotted nut and bolt attachment or by any other means in the art of creating a radially clamping force on a wheel. The soil plug cutters can also be attached directly to the adjustable clamps for adjusting the clamps or attached separate from the soil plug cutters. Where the soil plug cutters are attached to the clamps, this embodiment strengthens the stability of the soil plug cutters as well as the apparatus on the wheel.

In one embodiment of the present invention, the apparatus is adapted for mounting the apparatus to a plurality of wheel attachment bolt patterns. This can be accomplished by having multiple hole or slots adapted to accommodate various mounting bolt/nut patterns or other methods that account for the various bolt patterns in vehicle wheels. In one embodiment, the adaptation is built into the mounting plate while in another embodiment the adaptation is accomplished by mounting a secondary plate to the mounting plate with the adaptation built into the secondary plate.

In using the apparatus, the apparatus is bolted to the bolt pattern of the wheel and the plurality of clamps adjusted and tightened to grasp the tread of the wheel. The soil plug cutters are depth adjusted to create a plug of a desired depth. Then the vehicle is run over the lawn which one desires to cut plugs from and aerate. Every time a cutter comes to the bottom of the wheel it digs into the soil and pulls a plug. The vehicle is continually run over the lawn until the desired number of plugs are cut from the soil in the desired location.

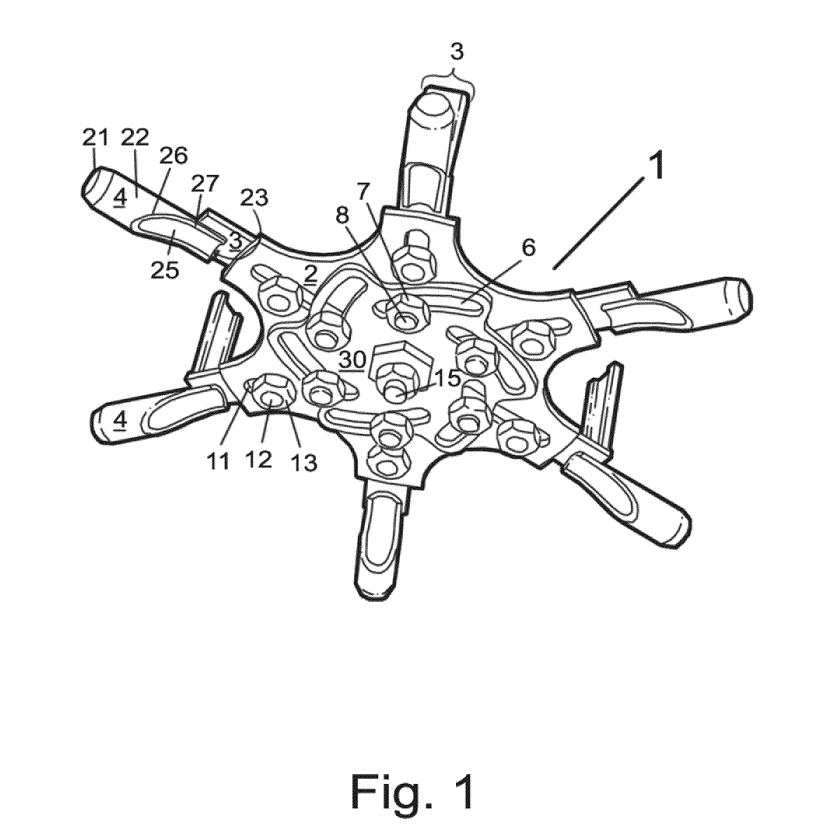

Now referring to the drawings, FIG. 1 depicts a perspective view of an embodiment of the present invention. Vehicle wheel aerating apparatus 1 consists of the mounting plate 2 the wheel tread clamps 3 and the cylindrical soil plug cutters 4. The mounting plate 2 is adapted in this view with slots 6, nuts 7, and bolts 8 to fit multiple wheel patterns. By sliding bolts and slots around, multiple bolt patterns can be accommodated. The wheel tread clamps 3 are adjustable in a radial manner by means of slot 11, bolt 12, and nut 13. A center bolt 15 is adapted to fit on the wheel axel to adapt and match the center points of both the wheel and the apparatus 1. Each of the soil plug cutters 4 are mounted to the clamps 3 and have a sharpened distal end 21 (made by tapering the metal to a point circumferentially) cylindrical sides 22 and a proximal end 23. In this configuration, cylinder opening 25 extends from the proximal end 23 past the middle of the cylinder and is tapered 26 toward the middle of the cylinder and straight across portion 27 toward the proximal end 23. In this embodiment, the mounted adjustable slots 6 are in a separate secondary plate 30.

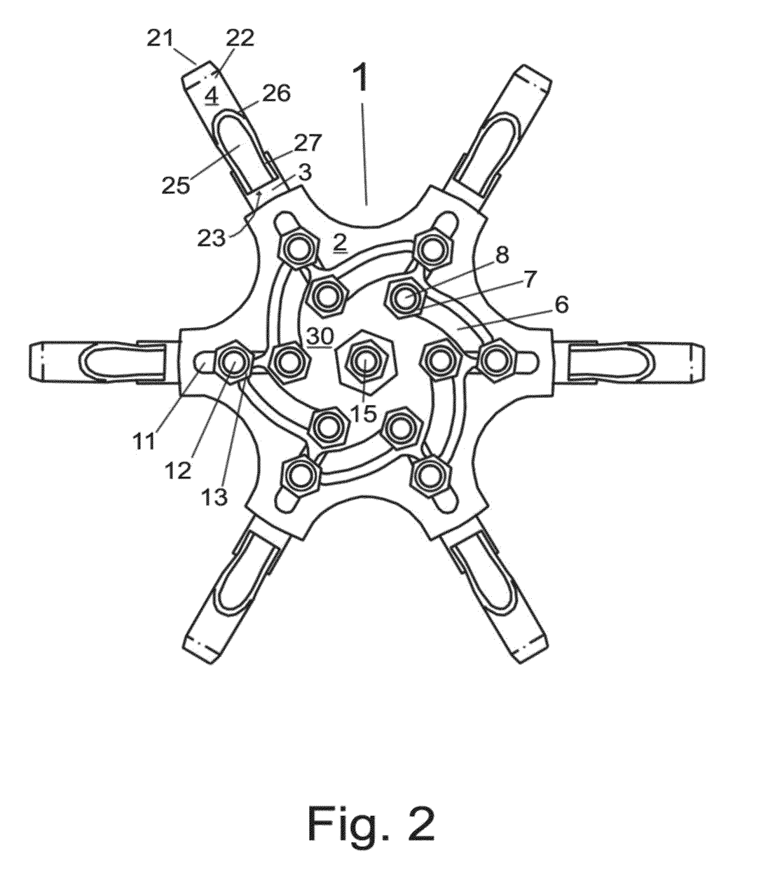

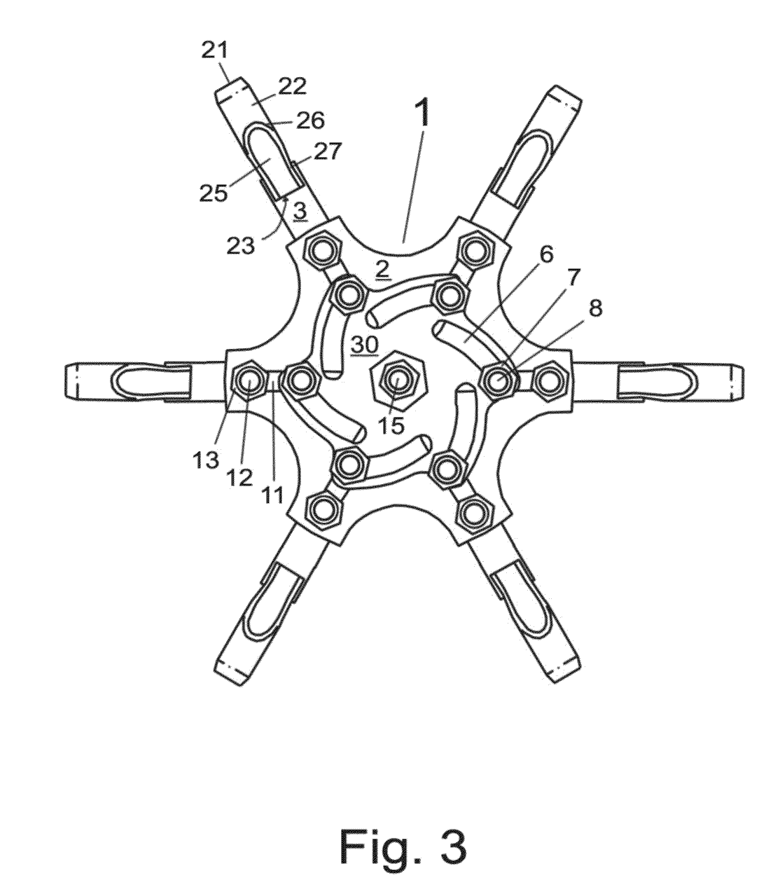

FIG. 2 depicts an embodiment of the present invention in a frontal view as it would be mounted on a wheel. The features depicted are the same as in FIG. 1 with the secondary plate 30 in one position and the clamps 3 in one position. FIG. 3 depicts a frontal view of the same apparatus 1 with the secondary plate 30 in a second position for mounting on a different wheel than in FIG. 2 with the clamps 3 shown in a more extended distal position.

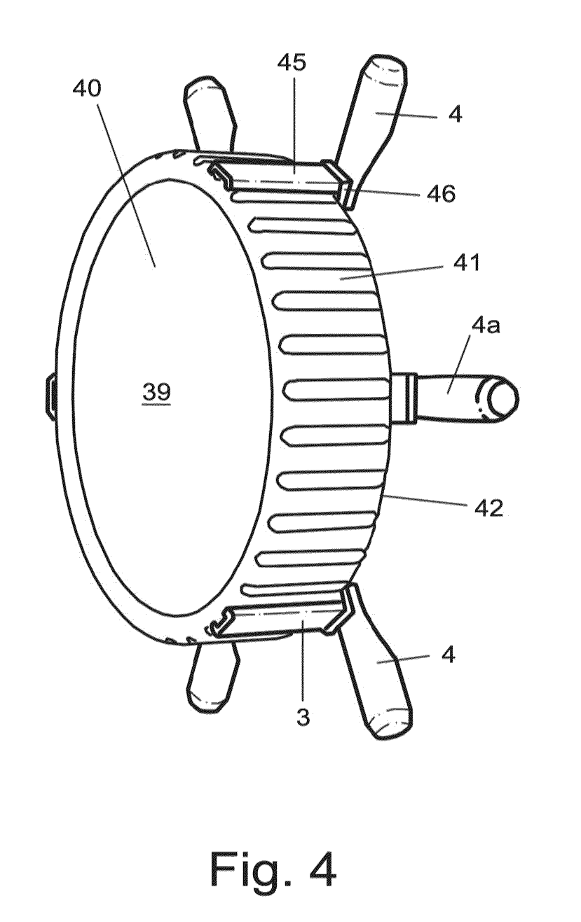

FIG. 4 depicts a perspective view of the back 39 of a vehicle wheel 40 having tread 41 and face 42 underneath. The clamp 3 has angled portion 45 and a portion parallel to the mounting plate 46. In this embodiment, clamps 3 are clamping tread 41 however, there is not a clamp 3 associated with each plug cutter 4 such that plug cutter 4a has no clamp associated with it. The number of clamps and cutters do not need to be equal in some embodiments, but are in some embodiments.

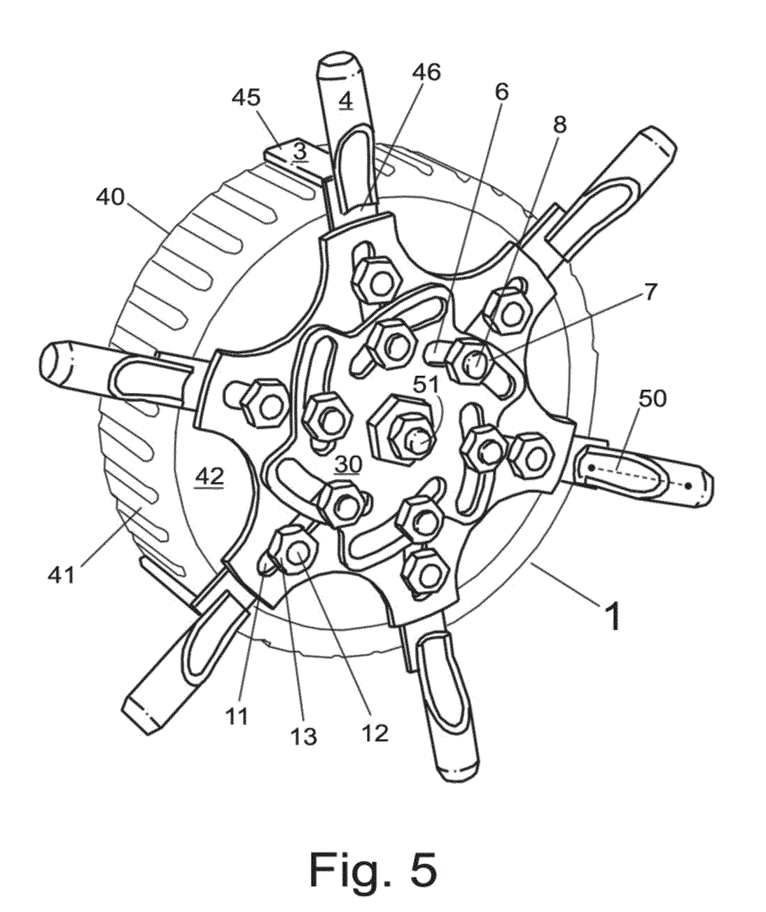

FIG. 5 depicts a perspective view of the apparatus 1 shown in other embodiments mounted to the face 42 of wheel 40. In this embodiment, the secondary plate 30 is adjusted to yet another position for mounting to this wheel 40. Also depicted is radius 50 which the cutter 4 is centered on in relationship to center point 51.

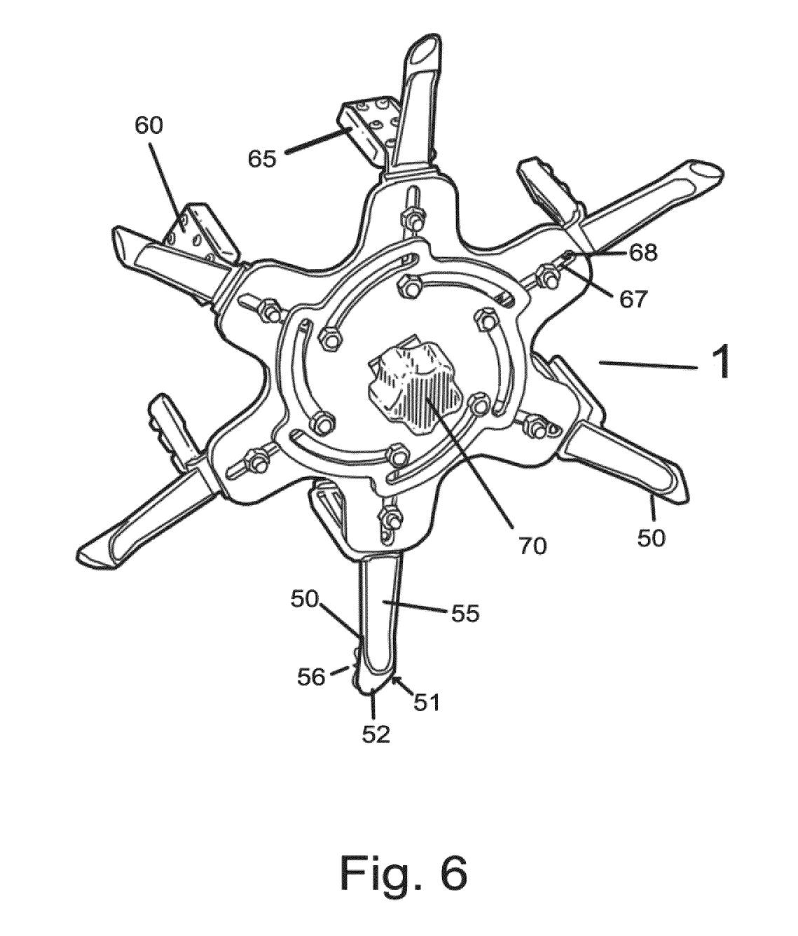

FIG. 6 depicts a perspective view of another embodiment of the present invention. In this perspective the plug cutters are designed differently. In this view, apparatus 1 has plug cutters 50. The plug cutter 50 has an angled tip 51 and bevel 52 though the bevel is not a required embodiment of the cutter 50. In this embodiment the opening 55 extends almost the entire length of the plug cutter 50 such that the opening is several times the length of the completely cylindrical distal part 56. Once again, the tapered nature of the opening 55 can be seen in this view. In this view, wheel tire clamps 60 are associated with each of the plug cutters 50. In addition, polymeric pads 65 are attached to the wheel clamps to allow for a different type of gripping surface and prevent the damage that metal could do. Note also, that the plug cutter 50, instead of a single attachment hole as shown in the previous figures designed to slide in slot 67, has a plurality of holes 68 for further extending the length of the plug cutter from the center point, and thus fitting a wider range of mower tire sizes. This view also shows twist knob 70 which replaces the center bolt in other embodiments and adds a quick tighten feature to this attachment nut.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

1. A lawn aerating apparatus designed for attachment to a face of a wheel of a vehicle, the wheel having a tread, a selected radius, a center point, wherein the wheel is attached to the face of the wheel by one or more attachment bolts and wherein the apparatus aerates by cutting one or more cylindrical soil plugs while the vehicle is traversing over a lawn comprising:
a) a mounting plate for mounting the apparatus to the face of the vehicle wheel by attachment to the vehicle wheel attachment bolts wherein the mounting plate has a center point designed to be adjacent to the wheel center point when the apparatus is attached to the face of the wheel;
b) one or more cylindrical soil plug cutters having a cylindrical side, a sharpened distal end, a proximal end and wherein a portion of the cylindrical side at the proximal end is open such that a soil plug cut with the distal end can pass through the cutter and fall out of the cylinder when it reaches the side opening, the plug cutters attached to the apparatus on the face of the wheel with the sharpened distal end facing distally on a radius from the center point of the mounting plate and positioned such that the sharpened distal end is at a greater distance from the mounting plate center point than the radius of the wheel; and
c) a plurality of adjustable clamps attached to the apparatus designed for clamping the apparatus to the tread of the vehicle wheel.

2. A lawn aerating apparatus according to claim 1 which further comprises an adjustable mounting plate adapted for a plurality of wheel attachment bolt patterns.

3. A lawn aerating apparatus according to claim 2 wherein the mounting plate is adjustable by use of a slot and bolt configuration.

4. A lawn aerating apparatus according to claim 1 wherein the adjustable clamps are adjustable bolted to the mounting plate.

5. A lawn aerating apparatus according to claim 4 wherein the clamps are adjustable by use of a slot and bolt configuration.

6. A lawn aerating apparatus according to claim 1 wherein each of the plug cutters are individually lawn depth adjustable separate from the mounting plate by use of a slot and bolt configuration.

7. A lawn aerating apparatus according to claim 1 wherein the plug cutters are mounted to the adjustable clamps.

8. A lawn aerating apparatus according to claim 1 wherein the side of the cylinder is open from about the middle of the cylinder to the proximal end.

9. A lawn aeration apparatus according to claim 1 wherein the cylinder side opening is tapered to open toward the proximal end.

10. A lawn aeration apparatus according to claim 1 which is mounted on the wheel of a vehicle the wheel having a selected radius.

11. A lawn aeration apparatus according to claim 10 wherein at least a portion of the cylinder side opening is positioned on the wheel at a distance from the center point greater than the wheel selected radius.

12. A lawn aeration apparatus according to claim 1 wherein the vehicle is a lawn mower.
